(19) United States
(12) Patent Application Publication
(10) Pub. No.: US 2022/0140445 A1
(43) Pub. Date: May 5, 2022

(54) BATTERY CELL MODULE, POSITIONING DEVICE FOR THE PRODUCTION OF BATTERY CELL MODULES, AND METHOD FOR THE PRODUCTION OF BATTERY CELL MODULES

(71) Applicant: SCIO TECHNOLOGY GMBH, Aschaffenburg (DE)

(72) Inventor: Alexander WEIS, Hösbach (DE)

(21) Appl. No.: 17/423,129

(22) PCT Filed: Jan. 16, 2019
(86) PCT No.: PCT/DE2019/100036

§ 371 Date: Jul. 15, 2021

(51) Int. Cl. H01M 50/505; H01M 50/213; H01M 10/04

(52) U.S. Cl. CPC H01M 50/505; H01M 10/0409; H01M 50/213

(57) ABSTRACT

Battery cell module for electrically operated vehicles, which has a plurality of elongated, in particular cylindrical, battery cells whose longitudinal axes are aligned parallel to one another, the battery cells being arranged in such a way that a first row of battery cells runs parallel to a second row of battery cells, so that in each case two battery cells are arranged opposite one another in pairs, the respectively opposite battery cells being electrically and mechanically rigidly connected to one another by means of at least one contact sheet in each case. In each case adjacent contact sheets are rigidly connected to one another electrically and mechanically by means of at least one contact sheet connector in each case.

### CROSS-REFERENCE TO RELATED APPLICATIONS

This application is a U.S. National Phase Application under 35 U.S.C. 371 of International Application No. PCT/DE2019/100036, filed on Jan. 16, 2019. The entire disclosure of the above application is incorporated herein by reference.

### BACKGROUND

This section provides background information related to the present disclosure which is not necessarily prior art.

### TECHNICAL FIELD

The invention relates to a battery cell module for storing electrical energy, in particular for use in electrically powered vehicles, for example electric scooters, electric cars, electric trucks, electric commercial vehicles or the like, or also for storage systems. The battery cell module has a plurality of elongated, in particular cylindrical, battery cells, which are electrically and mechanically rigidly connected to one another via contact sheets and via contact sheet connectors. The invention further relates to a positioning device for the production of a battery cell module as well as to a method for the production of battery cell modules.

### DISCUSSION

One problem with battery cell modules is that the modules heat up strongly during operation, especially under high load, and expand as a result. These temperature-dependent changes in volume, particularly in relation to the outer circumference of the battery cells, mean that the individual battery cells cannot be arranged next to each other in direct contact. Because of the resulting pressure, there is a risk that the cells, or in particular the cell connectors, or the entire module could be damaged. Therefore, when manufacturing battery cell modules, a distance must be maintained between the battery cells which is based on the expected thermal expansion of the individual battery cells. At the same time, performance requirements and the increasing demand for energy storage capacity on the one hand and the limited space available in electrically powered vehicles on the other make it necessary to fit as many cells as possible into a small space. Furthermore, a constant goal of further developments in the vehicle sector is to save material and weight in order to reduce costs and increase energy efficiency.

U.S. Pat. No. 7,332,243 B2 describes a battery cell module comprising a plurality of cylindrical battery cells which are held in defined relative positions to one another by means of a container. For this purpose, the container has separate compartments for each of the battery cells. In these, the battery cells are separated from each other in an upright position and at the same time arranged offset to each other. The container thus serves on the one hand as a cell holder and on the other hand, by holding the individual battery cells individually, as a separator which keeps the cells at a distance.

U.S. Pat. No. 8,519,715 B2 discloses a system for manufacturing battery cell blocks. A gripping device is shown with which a plurality of battery cells can be lifted and moved line by line. The gripping device engages the top surface of the cylindrical cells using either a magnet or a suction device. The gripping device is used for the purpose of placing cells line by line into a battery cell container.

The disadvantage here is that an additional element in the form of the container is required both for manufacturing the battery modules, in particular for positioning the battery cells for the welding process, and for spatially separating the battery cells from one another.

### SUMMARY

This section provides a general summary of the disclosure, and is not a comprehensive disclosure of its full scope or all of its features.

It is therefore one aspect of the present invention to overcome the disadvantages of the prior art, and in particular of improving a battery cell module for use in an electrically powered vehicle to the extent that it can avoid stresses due to thermal expansion with a particularly compact and material-saving design.

According to the invention, this problem is solved with the features of the independent claims.

Further advantageous embodiments are given in the dependent claims.

According to the invention, it is then envisaged to provide a battery cell module for electrically operated vehicles, which can have a plurality of elongated, in particular cylindrical, battery cells whose longitudinal axes are aligned parallel to one another, it being possible for the battery cells to be arranged in such a way that a first row of battery cells runs parallel to a second row of battery cells, so that in each case two battery cells are arranged opposite one another in pairs, it being possible for the respectively opposite battery cells to be electrically and mechanically rigidly connected to one another by means of at least one contact sheet in each case. In addition, adjacent contact sheets can in each case be electrically and mechanically rigidly connected to one another by means of in each case at least one contact sheet connector, it being possible for the battery cells in each case connected to one another by the at least one contact sheet to be kept spaced apart from one another by the respective at least one contact sheet. Further, the respective pairs of battery cells interconnected by the at least one contact sheet connector may be held spaced apart from each other by the respective at least one contact sheet connector. An elongated battery cell has a smaller extent in the plane perpendicular to its longitudinal axis relative to its longitudinal extent. The longitudinal axis of a cylindrical battery cell corresponds to its axis of rotation. Pairs of battery cells are connected to each other via a contact sheet, which is attached directly to both battery cells of the battery cell pair. In contrast, adjacent battery cells are not directly connected to each other via a contact sheet. Adjacent battery cells are indirectly connected to each other via the contact sheet of the first battery cell pair, the contact sheet of the second battery cell pair and the contact sheet connector connecting the contact sheets. The interconnected contact sheets and contact sheet connectors, whether welded or one-piece, can also be collectively referred to as cell connectors. By using the cell connector or connectors, the battery cell module does not require an additional cell holder, which determines the positioning of the cells relative to each other. By using one or more cell connectors, furthermore, no additional means is required to ensure spacing of the individual cells, or to keep the cells at a predefined distance from each other.

For example, a battery cell module can be scaled in the horizontal direction in such a way that it can have a different number of parallel cells. Thus, at least two opposing cells can be welded together or a multiple thereof without having to specify a maximum number. If a small number of cells are installed in parallel, for example 2, 4, 6, 8, small battery systems (power tools, robotics, e-bikes) can be built, for example. With a medium number of parallel cells, for example 10, 12, 14, 16, battery systems for scooters, two-wheelers or small vehicles can be built. With a large number of parallel cells, for example 18, 20, 22, 24, 26, or any more, systems for automotive applications, storage systems and boats can be built. Several battery cell modules can be interconnected to form a so-called macromodule, which in particular preferably has 13 battery cell modules. According to this modular system, the appropriate module size can be provided for different applications, for example for electric scooters, electric cars or as storage batteries. Furthermore, macromodules can be combined into battery systems for use in industry-specific overall systems, which have, for example, 8, 16, 24, 32 or 40 macromodules. This scalable, modular concept means that power ranges and capacities can be individually adapted to the respective application.

It may be provided that the distances between the longitudinal axes (X) of the battery cells (2) are selected so that the battery cells are not in contact with their outer surfaces, so that a free space is formed between adjacent and opposite battery cells. The contact sheet connecting the cells is preferably dimensioned or welded to the contact surfaces of the cells in such a way that, starting from the two longitudinal axes of the cells to be connected, the contact sheet overcomes the distance to the outer circumference of the respective cell and also bridges the cell gap to be maintained for the thermal expansion expected in operation. In addition, a manufacturing tolerance is preferably to be provided in the event that the contact sheet is attached to the contact surfaces deviating from the exact position of the longitudinal axis(es) of the battery cells or in order to compensate for deviations in the positioning of the cells relative to one another during module production. Furthermore, cell expansion to be expected over the service life of the cells can be taken into account in the distance dimensioning for the free space to be provided between the cells.

The distance is measured from the distance between the outer dimensions of the battery cells in the plane perpendicular to their longitudinal axes. The distance can be adjusted by positioning the cells relative to each other before they are rigidly welded together via the contact sheets or the contact sheet connectors.

Further, the adjacent battery cell pairs may be offset from each other such that the first and second rows of battery cells are parallel in a zigzag pattern. Preferably, the offset between the individual battery cell pairs is selected such that the outer circumference of one of the battery cells of a first battery cell pair projects into the free space between the cells of the adjacent second battery cell pair and the longitudinal axis of the battery cell projecting into the free space is at the level of the midpoint between the longitudinal axes of the second battery cell pair. As a result, this cell lies centrally between the cells of the adjacent battery cell pair. The advantage of this arrangement is that it minimizes the lateral distance between the battery cell pairs and at the same time allows the clearance to be maintained between all immediately adjacent battery cells for thermal expansion. The zigzag shape is designed so that the orientation of adjacent contact sheet connectors is opposite and the orientation of a contact connector next but one to a contact connector corresponds to its orientation.

Furthermore, the zigzag shape can be selected so that the longitudinal axes of all adjacent battery cells have the same distance from each other. This means that the longitudinal axes of three adjacent battery cells each form an equilateral triangle.

In addition, the battery cells can have contact surfaces spaced apart from one another along their longitudinal axes on their top sides and bottom sides, wherein the at least one contact sheet of the battery cells connected by means of the contact sheet can be fastened, in particular welded, to the respective contact surfaces of the connected battery cells on both top sides and/or on both bottom sides. Preferably, ultrasonic welding, laser welding or tungsten inert gas (TIG) welding are suitable welding methods. A battery cell of the cylindrical form preferably has a cylindrical body which is rotationally symmetrical about a longitudinal axis and has contact surfaces on its upper side and its lower side, respectively, for contacting the cell, it being possible for the positive terminal or the negative terminal to be provided on the upper or lower side of the battery cell.

Furthermore, the at least one contact sheet connector can be formed integrally with the contact sheets connected by it and adjacent to each other. The contact sheet connector can have a shape adapted to the alignment of the battery cell pairs with respect to each other. If the battery cell pairs do not have an offset to each other, the contact sheet connector can have a rectangular shape. If the battery cells have an offset, the contact sheet connector can preferably have a diamond-shaped contour. The advantage of this variably adaptable contour is that it ensures that the end faces of the contact sheet connector adjacent to the side faces of the contact sheets lie flat.

It may further be provided that the at least one contact sheet has two contact sections and a central web connecting the contact sections, the contact sections being rounded at the ends. Furthermore, the contact sections can be angled in steps from the center web in order to overcome any raised battery cell edges. Thereby, the contact sections are preferably aligned lying in the same plane. Preferably, the contact sections are aligned plane-parallel to the contact surfaces of the battery cells.

The contact sheet connectors can be formed together with the contact sheets as a one-piece sheet. Alternatively, the contact sheets and the contact sheet connectors can be formed separately and subsequently welded to form a unit or connected electrically and mechanically in some other way. For this purpose, the contact sheet connector can have at least two opposite end faces, the end faces each being connected to side faces of the connected contact sheets. The one-piece sheet or the contact sheets as well as the contact sheet connectors separately can be stamped out in the desired shape.

Furthermore, according to the invention, it is intended to provide a positioning device for the production of battery cell modules for electrically operated vehicles, with a carrier element for holding a plurality of positioning elements, wherein at least one of the positioning elements can have at least one battery cell receptacle pointing away from the carrier element and at least one positioning arm, which is connected to the carrier element with its side facing away from the battery cell receptacle, wherein the at least one battery cell receptacle is designed to receive and/or fix an outer circumferential section of an elongated, in particular cylindrical, battery cell.

The positioning device has the particular advantage of positioning a plurality of battery cells for welding to form a battery cell module in such a way that the battery cells are brought into a spaced welding position relative to one another by the device. By gripping the battery cells circumferentially, the welding operation can be performed on both the tops and bottoms of the cells while the battery cells are held by the positioning device.

The support element may have an abutment surface configured to hold a plurality of positioning elements. The carrier element can have associated through-openings for each of the positioning elements. The through-holes can each open into the battery cell receptacles in order to generate a vacuum there for sucking in or fixing the respective cells. The battery cell holder can further have at least one vacuum gripper. On its side facing away from the positioning elements, the carrier element can have a vacuum reservoir into which the respective through-openings open. The vacuum reservoir can be a groove-shaped recess. The vacuum reservoir can be closed by means of a closure element, which can be fixed to the back of the carrier sheet. For this purpose, the closure element can have through holes which open into corresponding blind holes in the carrier element. An annular seal surrounding the vacuum reservoir can be provided between the closure element and the carrier element, which seals the vacuum reservoir in a fluid-tight manner. The closure element can have a vacuum connection. The vacuum connection can be a through hole that opens into the vacuum reservoir. Furthermore, a robot mount can be provided on the closure element, by means of which the positioning device can be gripped by an industrial robot.

As an alternative to fixing the cells by means of a vacuum, it is also conceivable that the battery cell holders each have at least one magnet or electromagnet by means of which the battery cells can be gripped from the periphery.

For example, the battery cell holder can be formed integrally with the positioning arm. The battery cell holder preferably has suction elements surrounding the openings, which are designed to create a fluid-tight connection between the battery cell holder and the battery cell being held. The battery cell receptacle can have a complementary, in particular concave, shape to an outer circumferential section of the battery cell. The battery cell receptacles may each have a stop at their lower or upper end. The stop serves to adjust battery cells received by the battery cell receptacles to a common height. The stop can be designed as a protruding lip which limits the battery cell receptacle at the upper or lower end.

As an alternative to peripheral gripping, it is conceivable that the cells are each held by clamping between two gripping tongs provided on each of the battery cell holders, which clamp the cells in the longitudinal direction from the top and bottom. At least one of the gripping tongs can be adjustable horizontally or vertically, so that a battery cell is first picked up and then fixed between the gripping tongs. The cells are fixed between the grippers in such a way that the grippers only grip the edge areas of the cells so that there is sufficient space to place and weld the contact sheets and contact sheet connectors.

In this case, the plurality of positioning elements can be arranged side by side at a distance from one another on the carrier element, with the positioning arms of adjacent positioning elements having a difference in length so that the battery cell receptacles face away from the carrier element at different distances. The spacing of the positioning elements or the difference in length of the positioning arms is preferably selected so that battery cells received by the positioning elements are not in contact with their outer contours and, in addition, have a defined free space d between the outer contours. The spacing of the positioning elements on the carrier element can in particular be greater by a factor of V greater than the difference in length of the positioning arms.

Furthermore, the battery cell receptacles of the plurality of positioning elements can be arranged relative to each other such that the longitudinal axes of fixed battery cells can be aligned parallel to each other and the battery cells can be aligned with their outer surfaces not in contact with each other, so that a free space can be formed between adjacent battery cells in each case.

In addition, the positioning element can have at least one vacuum line which connects a through opening of the carrier element with an opening opening into the battery cell receptacle. Sealing elements can be provided between the contact surface of the carrier element and the contact sections of the positioning elements for fluid-tight sealing of the vacuum lines. Preferably, two vacuum lines can be provided for each positioning element. The vacuum lines preferably each open into the vacuum reservoir on the rear side of the carrier element facing away from the positioning elements.

Further according to the invention, it is provided to provide a method for manufacturing battery cell modules for electrically powered vehicles, comprising:
Accommodating at least two battery cells adjacent and spaced apart with a first positioning device;
Accommodating at least two battery cells adjacent and spaced apart with a second positioning device;
Moving the first and second positioning devices such that the battery cells received by the first positioning device are brought into a spaced, opposite position relative to the battery cells received by the second positioning device;
Welding of in each case a first battery cell, received by the first positioning device, to in each case a second battery cell, opposite the first battery cell and received by the second positioning device, by means of in each case at least one contact sheet to form in each case a battery cell pair, the at least two adjacent contact sheets being formed in one piece with a contact sheet connector connecting the contact sheets.

It can be provided that two positioning devices are used according to one of the embodiments described above, whereby the positioning arms of both positioning devices can be designed complementary to each other, so that opposing positioning arms have the same difference in length as adjacent positioning arms. As a result, when the positioning devices are brought opposite each other, a long and a short version of the positioning element can be opposite each other.

Picking up the battery cells can include gripping by means of a mechanical gripper or by means of a vacuum-operated device. Moving the positioning devices may be accomplished by means of pivoting devices or by means of robots. Welding may include welding at the tops and/or bottoms of the battery cells. It is conceivable that the battery cells received are first welded on the top or bottom side and the positioning devices are then swiveled by about 180° in order to subsequently weld the other side in each case.

Furthermore, it can be provided that neither the battery cells respectively accommodated in the first and the second positioning device nor the respectively opposing battery cells of a battery cell pair are in contact with their outer surfaces, so that a free space is formed between adjacent battery cells in each case. Preferably, the clearance formed between opposing battery cells corresponds to the clearance between adjacent battery cells. Preferably, the contact sheets and the contact sheet connectors are each welded tightly in such a way that the free spaces existing between the battery cells before welding correspond to the free spaces after welding. The clearances are therefore created by the positioning device before welding and by the contact sheets or contact sheet connectors after welding.

In particular, it may be provided that the welding of the battery cells by means of at least one contact sheet in each case to form a battery cell pair in each case:
welding the at least one contact sheet to the battery cell top side of the first and the second battery cell, respectively, and/or welding the at least one contact sheet to the battery cell bottom side of the first and the second battery cell, respectively.

The sheet of integrally joined contact sheets and contact sheet connectors can be gripped by a gripping device and then aligned on the array of positioned battery cells for the subsequent welding process. The gripping device may be a vacuum gripper engaging the sheet surface. Alternatively, the gripping device can be a mechanical gripper that grips the sheet laterally.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further features, advantages and characteristics of the invention can be seen in the following description of preferred embodiments of the invention with reference to the accompanying drawings, in which show:

FIG. 1 a perspective view of a top side of a battery cell module with cylindrical battery cells connected to each other via contact sheets and contact sheet connectors;

FIG. 2 a perspective view of a bottom side of a battery cell module with cylindrical battery cells connected to each other via contact sheets and contact sheet connectors;

FIG. 3 a top view of a battery cell module with spaced battery cells;

FIG. 4 a perspective view of a one-piece cell connector consisting of contact sheets and contact sheet connectors;

FIG. 5 a perspective view of a positioning device with positioning arms and battery cell receptacles;

FIG. 6 a top view of a positioning device and battery cell receptacles;

FIG. 7 a front view of a positioning device with adjacent battery cell receptacles and vacuum grippers;

FIG. 8 a perspective rear view of a positioning device with positioning elements arranged on a support element and a vacuum reservoir;

FIG. 9 a rear view of a positioning device with the closure element in place;

FIG. 10 a top view of an arrangement of two positioning devices arranged so that adjacent positioning arms each have the same length difference as opposite positioning arms;

FIG. 11 a front view of a micromodule received in a positioning device;

FIG. 12 a rear view of a micromodule received in a positioning device.

### DETAILED DESCRIPTION

Example embodiments will now be described more fully with reference to the accompanying drawings.

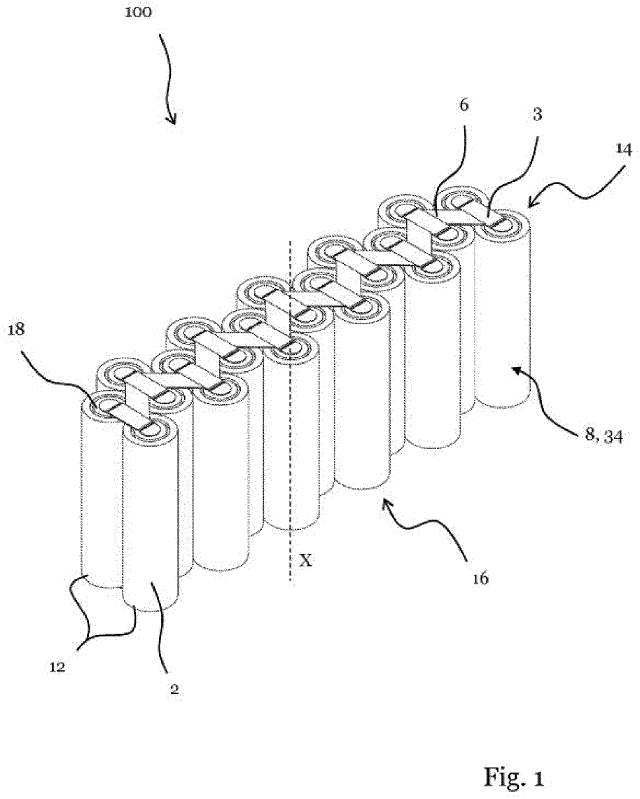

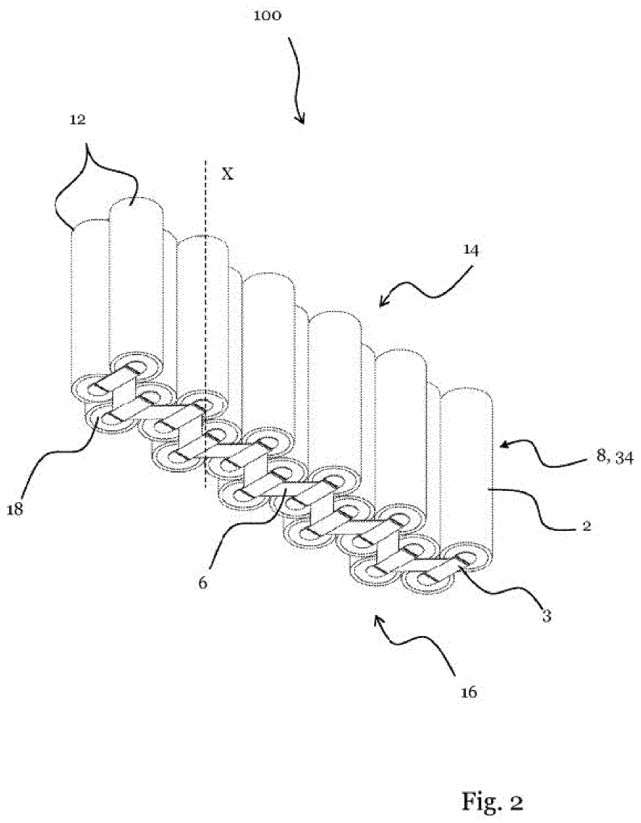

FIGS. 1 and 2 each show a battery cell module 100 having a plurality of elongated and cylindrical battery cells 2 arranged in a zigzag shape in a row of two. The zigzag shape runs such that adjacent battery cell pairs 12 each have an offset from one another, with the direction changing after each battery cell pair 12. In this case, one battery cell 2 of each battery cell pair 12 projects into one or two adjacent free spaces of the adjacent battery cell pairs 12, depending on whether the respective battery cell pair 12 is arranged between two further battery cell pairs 12 or on the outside of the battery cell module 100. In this case, the battery cells 2 projecting into the free spaces are each arranged at the level of the midpoint between the longitudinal axes X of the battery cells 2 of the adjacent battery cell pairs 12. The longitudinal axes X of the plurality of battery cells 2 are each aligned parallel to one another. Each battery cell 2 of the first row is in each case opposite a battery cell 2 of the second row, so that these opposite battery cells 2 each form a battery cell pair 12. The battery cell pairs 12 are each connected to one another via a contact sheet 3, which is welded to respective contact surfaces 18 of the battery cells 2. The contact sheets 3 are connected to one another via contact sheet connectors 6, which determine the course of the zigzag shape by means of a diamond shape and by projecting at an angle from the contact sheets 3 in each case. The battery cells 2 are each positioned relative to one another in such a way that the cylindrical surfaces 8 of the battery cells 2 are not in contact and a free space 10 is provided between the battery cells 2 in each case, which is designed for an expected thermally induced circumferential expansion of the battery cells 2. For the dimensioning of the free space 10, on the one hand the thermal expansion to be expected in operation must be taken into account, on the other hand the expansion of the battery cells 2 over their service life and furthermore a tolerance with regard to the positioning of the cells 2 relative to each other during the welding process.

FIG. 1 shows the upper side 14 of a battery cell module 100, whereby it can be seen that the positive terminals of the battery cells 2 are each aligned towards the upper side 14. This can be seen from the fact that a circular groove is formed between the contact surfaces 18 and the outer edge of the battery cells 2 in each case. The battery cell module 100 is thus connected in parallel. FIG. 2 shows the underside 16 of the battery cell module 100, to which the negative poles of the battery cells are connected in a zigzag manner via respective contact sheets 3 and contact sheet connectors 6. The negative poles can be recognized by the fact that the contact surfaces 18 are flat and do not have circular grooves like the positive poles.

The spaced positioning of the battery cells 2 relative to one another and the rigid mechanical connection of the battery cells 2 via the contact sheets 3 welded to the top and bottom of the battery cell module 100 and the contact sheet connectors 6 rigidly connected to the contact sheets 3 means that the battery cells 2 are contacted via the contact sheets 3 and the contact sheet connectors 6 on the one hand and are held by them at a distance from one another which is necessary for the thermal expansion of the battery cells 2 during operation. The battery cells 2 are therefore rigidly connected to each other, so that relative movements of connected cells 2 with respect to each other are prevented.

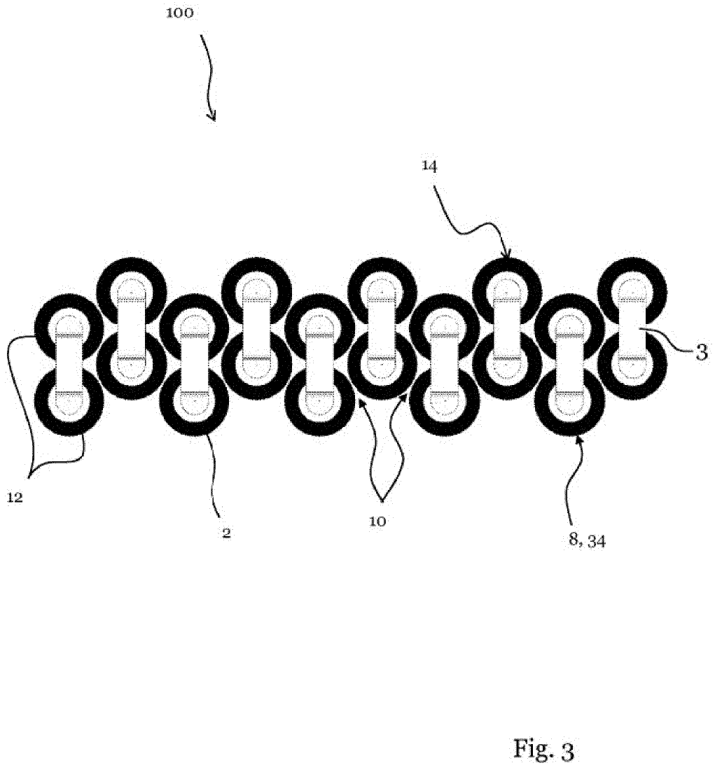

FIG. 3 shows a top view of a battery cell module 100, wherein the battery cell pairs 12 are each connected to each other via contact sheets 3 (the contact sheet connectors 6 are not shown for illustrative purposes). In particular, it can be seen that a clearance 10 is formed between all the battery cells 2 so that the outer surfaces 8 of the battery cells 2 are not in contact. The zigzag arrangement of the battery cells 2 with respect to each other is selected such that the free spaces 10 of the respective adjacent battery cells 2 are each of equal dimensions, or, respectively, that the distances between the outer surfaces 8 of the adjacent and opposing battery cells 2 are substantially equal. It can be seen that in each case one battery cell 2 of a battery cell pair 12 projects into one or two free spaces 10 of one or two adjacent battery cell pairs 12, and that the longitudinal axes X of these battery cells 2 are in each case at the level of the midpoint between the longitudinal axes X of the battery cells 2 of the one or both adjacent battery cell pairs 12.

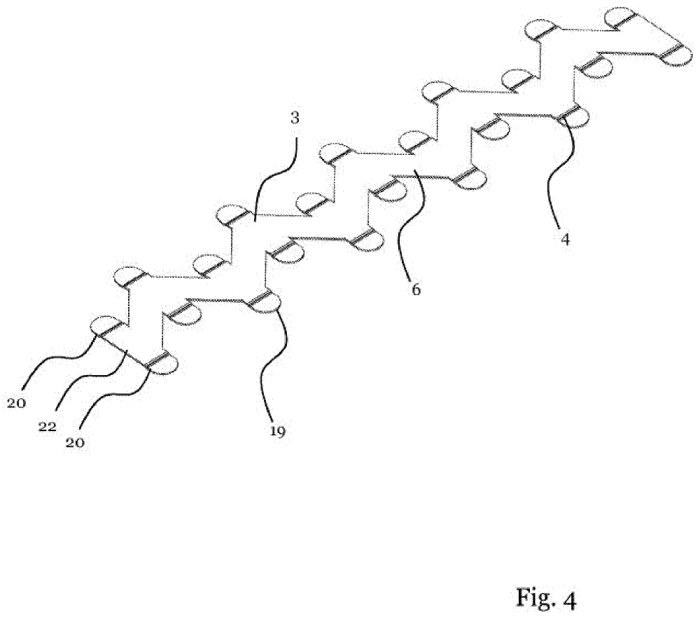

FIG. 4 shows a one-piece embodiment of a sheet or cell connector which has a plurality of contact sheets 3 and a corresponding number of contact sheet connectors 6. The sheet has the zigzag contour described above due to the obliquely extending contact sheet connectors 6. Each of the contact sheets 3 has a central web 22 and two contact sections 20 in each case, the contact sections 20 being intended to be welded to the contact surfaces 18 of the battery cells 2. For adaptation to the cylindrical battery cells 2 and their circular contact surfaces 18, the contact sections 20 each have circular end sections. The center web 22 connects the two contact sections 20 and is dimensioned to span the battery cells 2 to be connected and, moreover, to bridge the clearance 10 to be provided. In the embodiment shown, the contact sections 20 are angled in a shape from the center web 22. This is particularly necessary if the contact areas 18 are recessed above the outer rim of the battery cells 2.

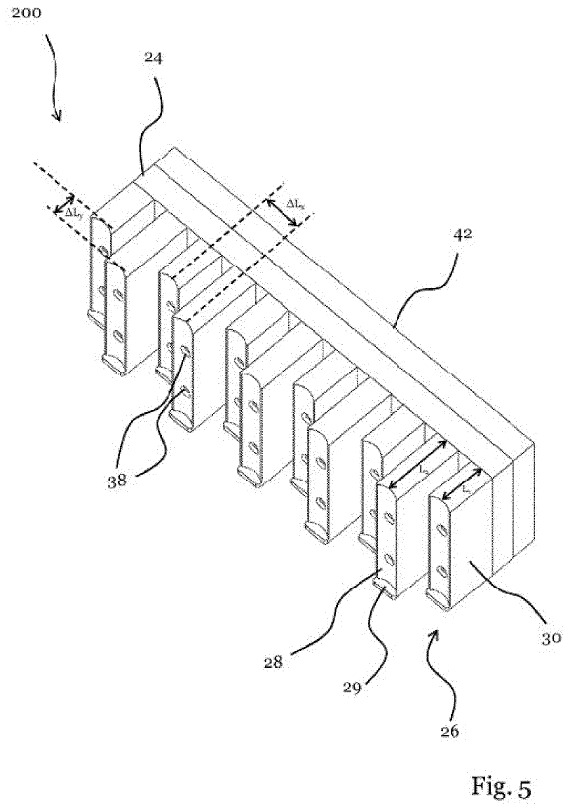

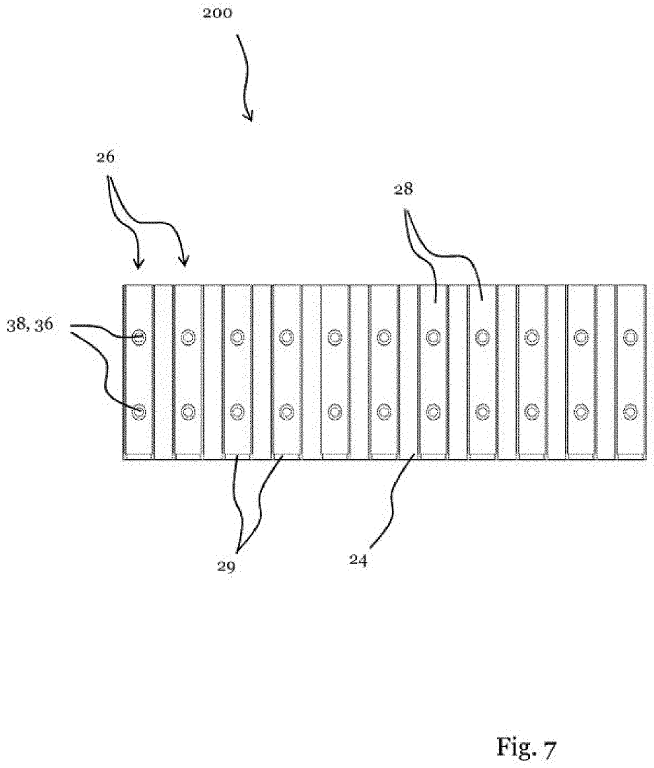

FIGS. 5-12 show the positioning device 200, which has a carrier sheet 24 on which, in the embodiments shown, eleven positioning elements 26 are arranged parallel to one another in each case. However, the number of positioning elements 26 on the carrier sheet 24 can be scaled down or up in any desired manner. Each positioning element 26 has a positioning arm 30, which is attached to or integrally formed with the carrier sheet 24. A battery cell receptacle 28 is provided at the end of each positioning element 26 remote from the carrier sheet 24. In the embodiments shown, the battery cell receptacles 28 each have two vacuum grippers for picking up and holding battery cells 2 or for subsequently unloading welded battery cell modules 100. Alternatively, it is conceivable that the battery cell receptacles 28 have other means for holding battery cells 2, as well as permanent magnets or electromagnets. For circumferential gripping of battery cells 2, the battery cell receptacles 28 each have an abutment surface with a concave shape. The contact surface extends in the longitudinal direction over at least half of the battery cells 2 to be gripped. The contact surface of the battery cell receptacle 28 extends to a maximum of half around the circumference of the battery cell 2 to be gripped. The concave shape serves in particular to align the battery cells 2 in the respective battery cell receptacle 28 correctly parallel to and at the correct distance from the other gripped battery cells 2. Thus, if a battery cell 2 is unintentionally gripped off-center or not parallel to the battery cell receptacle 28, the concave shape of the battery cell receptacle 28 ensures that the battery cell 2 is pulled in the direction of the vacuum grippers or magnets. The picked-up battery cell 2 is thus centered in the battery cell receptacle 28. A stop is provided at the lower end of each battery cell receptacle 28, which in the embodiments shown is in the form of a protruding lip 29. This stop serves to allow the gripped battery cells 2 to be longitudinally centered in each of the battery cell receptacles 28. It may happen that, although the gripped battery cells 2 are aligned laterally with respect to one another and parallel as described above, these are held at different heights in the respective battery cell receptacles 28 or have different distances from the lips 29. In order to center the cells 2 at one height, provision can be made to briefly release the received battery cells 2 so that they slide down along the contact surfaces onto the respective stops due to their weight force. In this context, releasing means loosening or at least loosening the grip by the vacuum grippers or the electromagnet. Alternatively, it can be provided that the battery cells 2 in the gripped state are pressed down onto the stops 29 by means of a hold-down device, for example in the form of a sheet.

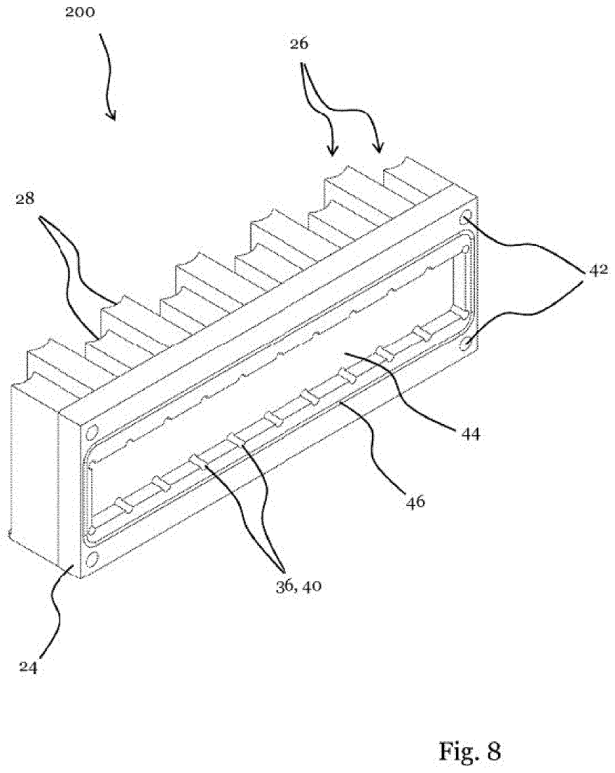

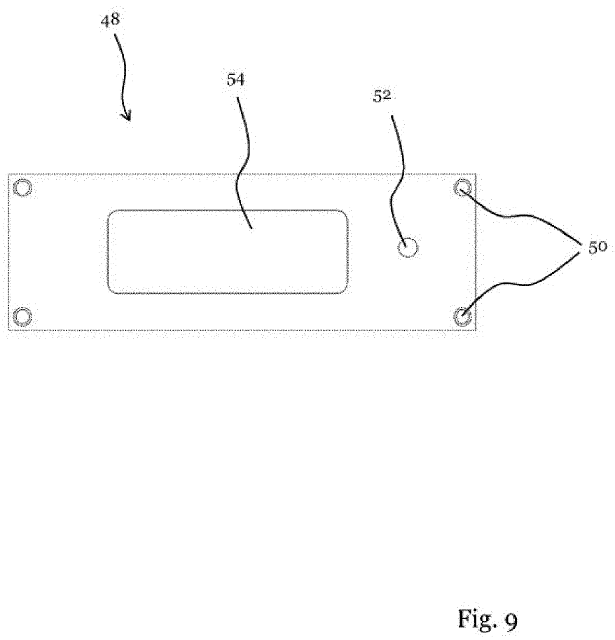

The vacuum grippers are designed in such a way that the contact surfaces of the battery cell receptacles 28 each have openings 38 which open into vacuum lines which can be provided in the positioning arms 30, as shown in FIGS. 5-7. These vacuum lines 36 open into through-holes 40 on the carrier sheet side, which are shown in FIG. 8 and open into a vacuum reservoir 44 on the rear side of the carrier sheet 24, via which the required vacuum can be provided for the positioning elements. The vacuum reservoir 44 extends to the rear of the carrier sheet 24 in accordance with the lateral spread of the positioning elements 26 and the arrangement of the vacuum grippers in the longitudinal direction of the battery cells 2 to be accommodated in the respective battery cell receptacles 28. For fluid-tight closure of the vacuum reservoir 44, an annular seal 46 is provided which surrounds the reservoir in an annular manner. FIG. 9 shows a closure element 48 for closing the vacuum reservoir 44, which can be attached to the carrier sheet 24 via through-holes 50 in corresponding threaded holes 42 in the carrier sheet 24. The closure element 48 further includes a vacuum port 52 in the form of a through bore opening into the vacuum reservoir 44. The vacuum reservoir can be evacuated via the vacuum port 52, and the vacuum grippers disposed in the battery cell receptacles 28 can be actuated therefrom. Furthermore, the closure element has a receptacle 54 via which the unit comprising positioning elements 26, carrier sheet 24 and closure element 48 can be gripped and fixed by means of a handling module.

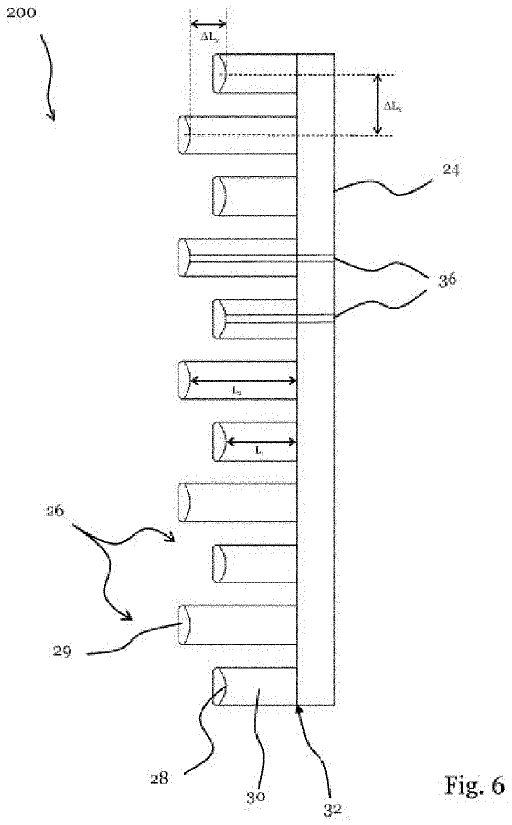

FIGS. 5 and 6 further show that respective adjacent positioning arms 30 have a length difference ΔLy, which results from the length difference L2−L1 of the positioning arms. Furthermore, it is shown that the positioning elements 26 each have a lateral distance ΔLx from each other. If the same free space d is provided between all battery cells 2 in each case and the battery cells 2 each have the same cell diameter Z, the lateral distance ΔLx between the positioning elements 26 is greater by a factor of \sqrt{3} greater than the difference in length ΔLy of the positioning arms. This results from the fact that with equal distances d between adjacent battery cells 2 with the same cell diameter Z in each case, their longitudinal axes X each form an equilateral triangle whose internal angles α are all 60°. This results in the lateral distance ΔLx of the positioning elements 30:

ΔLx=(Z+d)×sin(α)

and for the length difference ΔLy of the positioning arms 30:

ΔLy=(Z+d)×cos(α),

so that for an angle of 60° the factor:

$$\frac{Δ Lx}{Δ Ly} = \sqrt{3} follows .$$

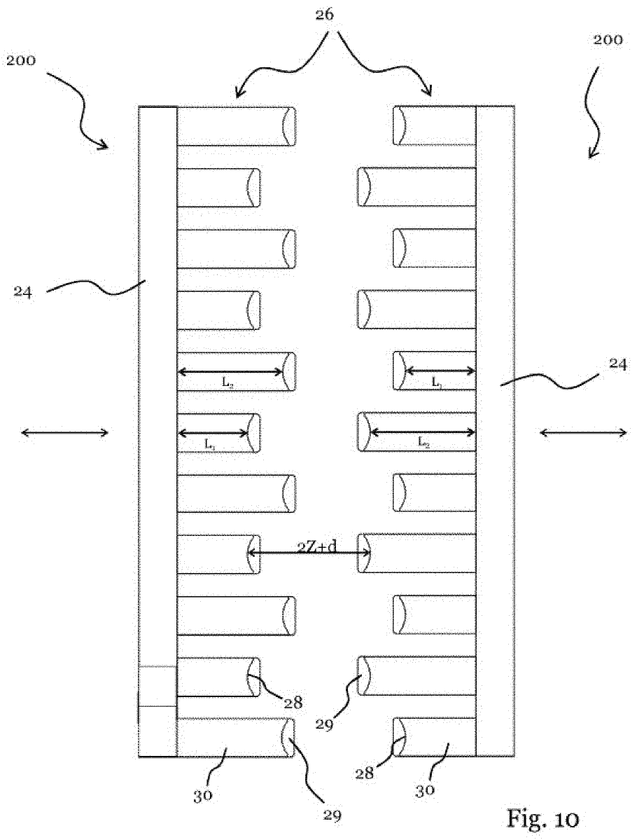

FIG. 10 shows an exemplary arrangement of two positioning devices 200 with respect to each other, which is necessary for manufacturing a battery cell module 100. In this case, a first positioning device 200 is positioned opposite a second positioning device 200 in such a way that the positioning elements 26 each point to one another. The positioning devices 200 are further designed to be complementary to one another, so that a positioning element 26 of length L1 of the second positioning device 200 is assigned opposite each positioning element 26 of length L2 of the first positioning device 200, and a positioning element 26 of length L2 of the second positioning device 200 is assigned opposite each positioning element 26 of length L1 of the first positioning device 200. As a result, positioning elements 26 arranged adjacent to each other on the carrier sheet 24 of the first or the second positioning device 200 have the same length difference ΔLy as respectively opposite positioning elements 26 of the first and the second positioning device 200. The number of positioning elements of length L1 of the first positioning device 200 corresponds to the number of positioning elements of length L2 of the second positioning device 200 and vice versa.

To produce the battery cell modules 100, each positioning device 100 receives a plurality of battery cells 2 via its battery cell receptacle 28. The cylindrical and elongated battery cells 2 are gripped circumferentially so that the cylindrical outer surface of the battery cells 2 rests against the concave contact surface of the battery cell receptacles 28 and the longitudinal axes X of the battery cells 2 are aligned parallel to one another. Preferably, all positive poles of the accommodated cells 2 can be oriented upwards and all negative poles downwards, or vice versa. To pick up the battery cells 2, the positioning devices 200 can be linearly moved or given away in multiple axes via handling modules. When the battery cells 2 are respectively gripped by the positioning devices 200, they are positioned opposite each other such that the battery cells 2 of both positioning devices 200 are at the same height and all axes X of the cells 2 are aligned parallel to each other. Furthermore, the positive poles and the negative poles of all gripped battery cells 2 preferably each point in the same direction. The positioning devices 200 are positioned opposite each other in such a way that a free space d remains between the respective opposing battery cells 2 and the outer surfaces of the battery cells 2 are not in contact. Accordingly, the distance between two battery cell receptacles is 2Z+d once the positioning devices are moved to their final spaced position. Whereby the final spacing position describes the distance at which the received battery cells 2 are welded together via the cell connector. Subsequently, the battery cells 2 are centered to a height via the stops or the lips 29. This position of the cells relative to each other now corresponds to the desired positioning in the welded state. The preferably one-piece sheet consisting of contact sheets 3 and contact sheet connectors 6 is then placed on the oppositely positioned battery cells 2 and positioned in such a way that each contact surface 18 of each battery cell 2 is assigned a contact section 20. Alternatively, individual contact sheets 3 and contact sheet connectors 6 can be used. The contact sections 20 are then each welded to the associated contact surface 18.

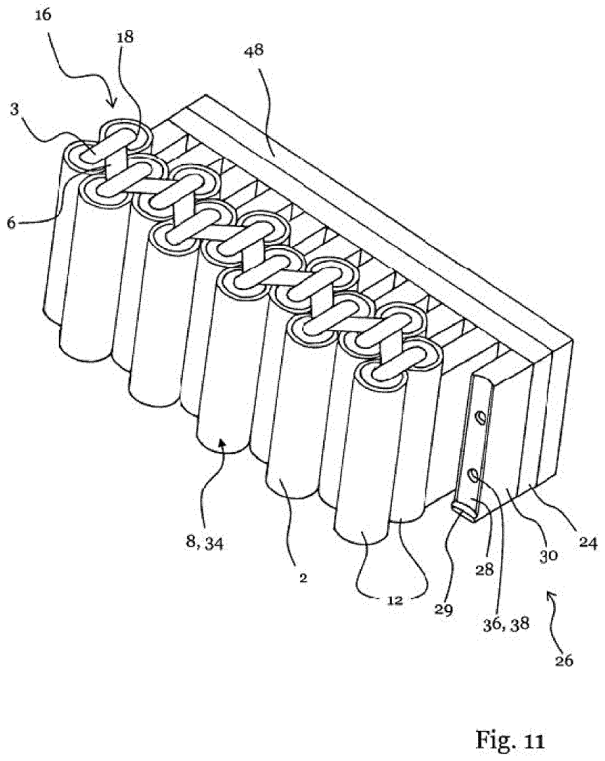

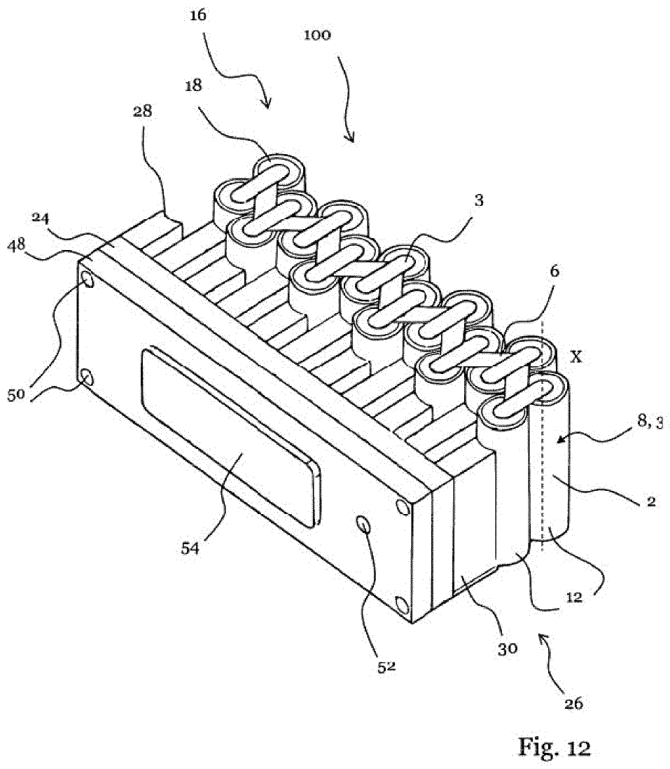

FIGS. 11 and 12 show an example of a battery cell module 100 held by a positioning device 200, in which the battery cells 2 are mechanically rigidly and electrically connected to one another via the welded-on contact sheets 3 and the contact sheet connectors 6, respectively, with a free space d being formed between all adjacent and opposing cells 2 in each case, so that the individual cells 2 do not touch one another. For illustrative purposes, one of the positioning elements 26 shown is not occupied. For depositing the module 100, this is held and transferred from a positioning device 100 by means of the handling module to a target location and deposited there by applying air to the vacuum grippers or by interrupting the voltage of the electromagnets.

The features disclosed in the foregoing description, figures, and claims may be significant both individually and in any combination for the realization of the invention in the various embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A battery cell module for electrically operated vehicles, comprising a plurality of elongated, in particular cylindrical, battery cells whose longitudinal axes are aligned parallel to one another, the battery cells being arranged in such a way that a first row of battery cells runs parallel to a second row of battery cells, so that in each case two battery cells are arranged opposite one another in pairs, the battery cells are each positioned relative to one another such that the cylindrical surfaces of the battery cells are not in physical contact and a respective clearance is provided between the battery cells which is configured for an expected thermally induced circumferential expansion of the battery cells;
the respective opposing battery cells being electrically and mechanically rigidly connected to one another by means of at least one contact sheet in each case;
and wherein in each case adjacent contact sheets are electrically and mechanically rigidly connected to one another by means of in each case at least one contact sheet connector,
wherein the battery cells connected to one another in each case by the at least one contact sheet are held spaced apart from one another by the respective at least one contact sheet, and wherein the battery cell pairs connected to one another in each case by the at least one contact sheet connector are held spaced apart from one another by the respective at least one contact sheet connector.

2. (canceled)

3. The battery cell module, according to claim 1, wherein adjacent battery cell pairs are offset from each other such that the first and second rows of battery cells are parallel in a zigzag shape.

4. The battery cell module according to claim 3, wherein the zigzag shape is selected such that the longitudinal axes of all respectively adjacent battery cells have the same distance from each other.

5. The battery cell module according to claim 1, wherein the battery cells have contact surfaces spaced apart from one another along their longitudinal axes on their upper sides and their lower sides in each case, wherein the at least one contact sheet of the battery cells connected by means of contact sheets is fastened, in particular welded, to the respective contact surfaces of the connected battery cells on both upper sides and/or on both lower sides in each case.

6. The battery cell module according to claim 1, wherein the at least one contact sheet connector is formed integrally with the contact sheets connected thereto and adjacent to one another.

7. The battery cell module according to claim 1, wherein the at least one contact sheet has two contact sections and a central web connecting the contact sections, wherein the contact sections are rounded at the ends.

8. A positioning device for the production of battery cell modules for electrically powered vehicles according to claim 1, having a carrier element for holding a plurality of positioning elements, at least one of the positioning elements having at least one battery cell receptacle pointing away from the carrier element, and at least one positioning arm which is connected to the carrier element by its side facing away from the battery cell receptacle, the at least one battery cell receptacle being designed to receive and/or fix an outer circumferential section of an elongate, in particular cylindrical, battery cell.

9. The positioning device of claim 8, wherein the plurality of positioning elements are spaced side-by-side on the support member, the positioning arms of adjacent positioning elements having a length difference such that the battery cell receptacles face different distances away from the support member.

10. The positioning device according to claim 8, wherein the battery cell receptacles of the plurality of positioning elements are arranged with respect to each other such that the longitudinal axes of fixed battery cells are parallel to each other and the battery cells can be aligned with their outer surfaces not in contact with each other, so that a free space can be formed between adjacent battery cells, respectively.

11. The positioning device according to claim 8, wherein the battery cell holder comprises at least one of a vacuum gripper and an electromagnetic gripper.

12. A method of manufacturing battery cell modules for electrically powered vehicles, comprising:
Adjacent and spaced apart pickup of at least two battery cells with a first positioning device;
Adjacent and spaced picking of at least two battery cells with a second positioning device;
Moving the first and second positioning devices such that the battery cells received by the first positioning device are brought into a spaced, opposite position to the battery cells received by the second positioning device with respect to each other;
Welding in each case a first battery cell received by the first positioning device to in each case a second battery cell opposite the first battery cell and received by the second positioning device by means of in each case at least one contact sheet to form in each case a battery cell pair, the at least two adjacent contact sheets being formed integrally with a contact sheet connector connecting the contact sheets.

13. The method according to claim 12, further comprising:
using two positioning devices for the production of battery cell modules for electrically powered vehicles, each of the two positioning devices having a carrier element for holding a plurality of positioning elements, at least one of the positioning elements having at least one battery cell receptacle pointing away from the carrier element, and at least one positioning arm which is connected to the carrier element by its side facing away from the battery cell receptacle, the at least one battery cell receptacle being designed to receive and/or fix an outer circumferential section of an elongate, in particular cylindrical, battery cell;
wherein the positioning arms of both positioning devices are formed complementary to each other, so that opposing positioning arms have the same length difference as adjacent positioning arms.

14. The method of claim 12, wherein neither the battery cells respectively received in the first and second positioning devices nor the respectively opposing battery cells of a battery cell pair are in contact with their outer surfaces, so that a free space is formed between adjacent battery cells respectively.

15. The method of claim 12, wherein welding the battery cells by means of at least one contact sheet in each case to form a battery cell pair in each case comprises:
welding the at least one contact sheet to the battery cell upper side of the first and the second battery cell, respectively, and/or welding the at least one contact sheet to the battery cell lower side of the first and the second battery cell, respectively.
